(19) United States
(12) Patent Application Publication
(10) Pub. No.: US 2020/0094864 A1
(43) Pub. Date: Mar. 26, 2020

(54) OPERATION INPUT DEVICE

(71) Applicant: KABUSHIKI KAISHA TOKAI RIKA DENKI SEISAKUSHO, Aichi (JP)

(72) Inventors: Masahiro TAKAHASHI, Aichi (JP); Ryoko NAKANO, Aichi (JP)

(21) Appl. No.: 16/321,621

(22) PCT Filed: Jun. 13, 2017
(86) PCT No.: PCT/JP2017/021828

§ 371 Date: Jan. 29, 2019

(30) Foreign Application Priority Data
Aug. 3, 2016 (JP) 2016-152708

(51) Int. Cl. B62D 1/04; G06F 3/0482; G06F 3/044

(52) U.S. Cl. CPC B62D 1/046; B60K 2370/143; G06F 3/044; G06F 3/0482

(57) ABSTRACT

An operation input device includes a touch detector configured to detect an operation state to an operation unit of a steering wheel of a vehicle, a controller configured to determine an operation command by fingers of an operator to the touch detector based on a touch state of the fingers of the operator to the touch detector and to operate an operation target device, and a notification unit for notifying the operator based on the operation command by the fingers determined by the controller.

### TECHNICAL FIELD

The present invention relates to an operation input device.

### BACKGROUND ART

There is known an operation input device having a camera configured to capture an image of a predetermined detection region including at least a part of spokes connected to a steering wheel for steering a vehicle, an extraction means for extracting a shape of a hand and/or a movement of the hand of a driver, based on a captured image of the camera, a determination means for determining a hand command (operation command by fingers) corresponding to the shape of the hand and/or the movement of the hand extracted by the extraction means and an execution means for executing the hand command determined by the determination means (for example, see Patent Document 1).

This operation input device is set with an input position of the hand command being at the spokes that are not held during an operation of the steering wheel, that is, with setting a detecting region, a command input and a steering operation can be surely differentiated. Thus, it is considered that the operation input device can accurately recognize an operation input without incorrectly judging the shape of the hand, during a steering operation, as the hand command

### CITATION LIST

### Patent Document

Patent Document 1: JP 2006-298003A

### SUMMARY OF INVENTION

### Technical Problem

The operation input device disclosed in Patent Document 1 limits a detection region to spokes that are not being held during an operation of a steering wheel for accurately recognizing an operation input by differentiating a command input and a steering wheel operation. However, from a viewpoint of operability, it is preferable that an operator be able to perform a gesture while holding a steering wheel.

It is an object of the invention to provide an operation input device that enables input by finger gestures and notification to fingers while holding the steering wheel.

### Solution to Problem

[1] An operation input device according to a first embodiment of the invention includes a touch detector configured to detect an operation state to an operation unit of a steering wheel of a vehicle, a controller configured to determine an operation command by fingers of an operator to the touch detector based on a touch state of the fingers of the operator to the touch detector and to operate an operation target device and a notification unit for notifying the operator based on the operation command by the fingers determined by the controller.

[2] The operation input device described in the above-mentioned [1] in which the operation command by the fingers is a gesture input by a hand of the operator may be provided.

[3] Further, the operation input device described in the above-mentioned [1] or [2] in which the touch detector is of an electrostatic capacitance sensor may be provided.

[4] Moreover, the operation input device described in any one of the above-described [1] to [3] in which notification by the fingers based on an operation command is a display of an operation menu of the operation target device may be provided.

[5] The operation input device described in any one of the above-described [1] to [3] in which notification by the fingers based on an operation command is a display of a projected image on the fingers of the operator may be provided.

[6] The operation input device described in any one of the above-described [1] to [3] in which notification by the fingers based on an operation command is a vibration presentation to the fingers of the operator may be provided.

[7] The operation input device described in the above-described [1] or [3] in which the operation unit of the steering wheel includes an electrostatic sensor built-in grip, and the touch detector is mounted on a front surface of the electrostatic sensor built-in grip may be provided.

[8] The operation input device described in [1], [3] or [7], in which the touch detector includes an operation input portion may be provided. The operation input portion has a plurality of driving electrodes arranged with equal intervals inbetween in a predetermined direction, a plurality of detection electrodes arranged with equal intervals inbetween in an orthogonal direction to the predetermined direction, a driving unit configured to provide driving signals to the plurality of driving electrodes, and a reading unit configured to read out electrostatic capacitance generated by a combination of the plurality of driving electrodes and the plurality of detection electrodes.

[9] The operation input device described in [1] or [5] in which notification by the fingers based on an operation command is a projected image displayed on a hand of the operator while holding the operation unit of the steering wheel may be provided.

### Advantageous Effects of Invention

According to an embodiment of the invention it is possible to provide an operation input device that enables input by finger gestures and notification to fingers while holding a steering wheel.

### BRIEF DESCRIPTION OF DRAWINGS

FIG. 1 is a schematic diagram illustrating an interior of a vehicle in which an operation input device according to an embodiment is installed.

FIG. 2 is a schematic diagram illustrating a signal transmission of an operation input device.

FIG. 3A is a front view of a steering wheel including a touch sensor as an operation unit.

FIG. 3B is a schematic diagram illustrating the touch sensor (development view) and its controller.

FIG. 4A is a front view illustrating an example of a gesture when holding a touch sensor with one finger being extended to perform a slide operation in a direction of an arrow A.

FIG. 4B is a front view illustrating an example of a gesture when holding a touch sensor with one finger being extended to move the finger (forefinger) in a vertical direction of an arrow B.

FIG. 4C is a front view illustrating an example of a gesture when raising four fingers.

FIG. 5A is a schematic diagram illustrating a touch region of a touch sensor (development view) corresponding to FIG. 4A as a hatching region.

FIG. 5B is a schematic diagram illustrating a touch region of a touch sensor (development view) corresponding to FIG. 4B as a hatching region.

FIG. 5C is a schematic diagram illustrating a touch region of a touch sensor (development view) corresponding to FIG. 4C as a hatching region.

FIG. 6A is a schematic diagram illustrating an example of a main menu displayed on a display portion by the gesture operation illustrated in FIG. 4A.

FIG. 6B is a schematic diagram illustrating an example of a selection menu of A displayed on a display portion by the gesture operation illustrated in FIG. 4B.

FIG. 6C is a schematic diagram illustrating an example of a selection menu of A′ displayed on a display portion by the gesture operation illustrated in FIG. 4C.

### DESCRIPTION OF EMBODIMENT

### Embodiments of Present Invention

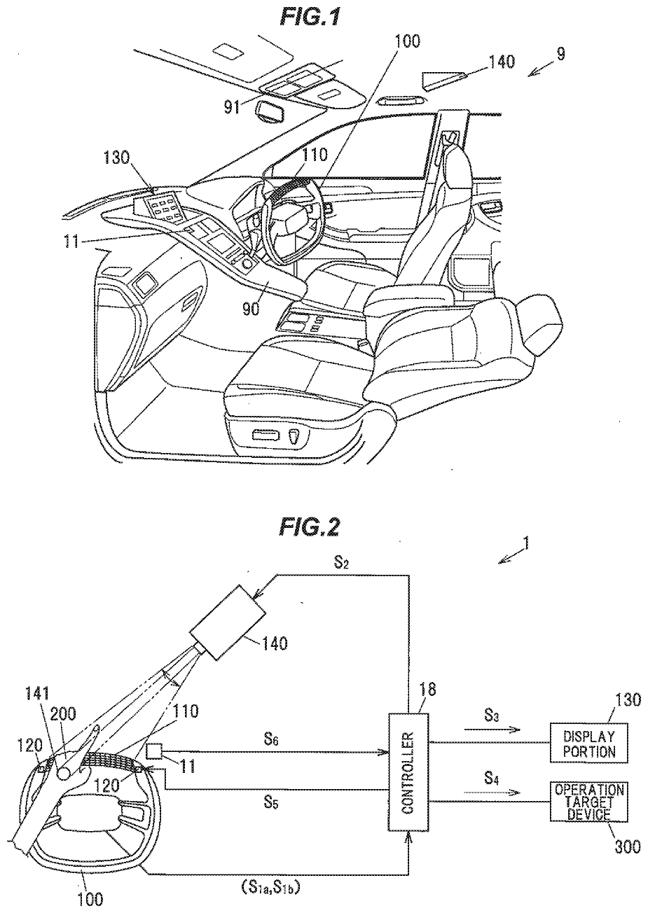

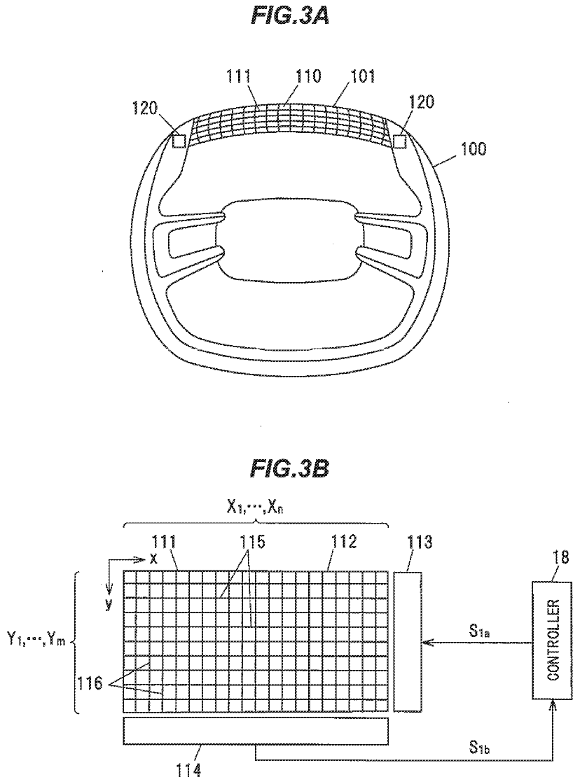

FIG. 1 is a schematic diagram of the interior of a vehicle in which an operation input device according to an embodiment is installed. FIG. 2 is a schematic diagram illustrating a signal transmission of the operation input device. FIG. 3A is a front view of a steering wheel including a touch sensor as an operation unit, and FIG. 3B is a schematic diagram illustrating the touch sensor (development view) and a controller thereof.

An operation input device 1 includes a touch sensor 111 that is a touch detector configured to detect an operation state to an operation unit 101 of a steering wheel 100 of a vehicle 9, a controller 18 configured to determine an operation command by fingers of an operator to the touch sensor 111 based on a touch state of the fingers 200 of the operator to the touch sensor 111 and to operate an operation target device and a notification unit for notifying the operator based on the operation command by the fingers determined by the controller 18.

As the notification means, as illustrated in FIG. 2 and the like, a display portion 130, a projection portion 140 and a vibration actuator 120 are included.

As illustrated in FIGS. 1 to 3, the steering wheel 100 is installed in the vehicle 9, and an electrostatic sensor built-in grip 110 is mounted on the operation unit 101 of the steering wheel 100. Further, the steering wheel 100 is mounted with the vibration actuator 120 so that a driver may receive a tactile sensation presentation while holding the steering wheel. A center console 90 is mounted with the display portion 130 on which an operation status of the operation input device 1 is displayed at a position visible from the driver and a microphone 11 used for voice input is also provided. On a ceiling 91 of the vehicle, the projection portion 140 is mounted and a display image 141 may be projected on the back of the hand of the driver.

The operation input device 1 includes a controller 18 configured to determine an operation command by fingers to the touch sensor 111 based on a touch state of the fingers 200 of the operator to the touch sensor 111, and the controller 18 is configured to operate an operation target device 300 based on the operation command by the fingers and to perform notification (display of menu and the like by display portion 130, image projection to fingers 200 by projection portion 140 and tactile sensation feedback to the fingers 200 by vibration actuator 120) to fingers 200 based on the operation command of the fingers.

The operation input device 1 is configured to perform notification as a feedback for the operation input by the gesture operation while the touch sensor 111, provided at the top portion of the steering wheel, as the operation unit 101 of the steering wheel 100 of the vehicle 9 is being held. The notification includes a display to HUD, the display portion 130 or the like, projection display to the back of the hand, a tactile sensation feedback to the fingers 200 by vibration, and the like. Thus, it is possible to include a traffic status in the forward direction, the operation unit 101 and the fingers 200 in the same view and to make various types of notification to the fingers 200 performing the input operations at the same time. This results in enabling safe operations.

### Configuration of Controller 18

The controller 18 is, for example, a microcomputer including a Central Processing Unit (CPU) that carries out computations, processes, and the like on acquired data in accordance with stored programs, Random Access Memory (RAM) and Read Only Memory (ROM) that are semiconductor memories, and the like. A program for operations of the controller 18, for example, is stored in the ROM. The RAM is used as a storage region that temporarily stores computation results and the like, for example, and detection value distribution information 150 and the like are generated. The controller 18 also includes an internal means for generating a clock signal, and operates on the basis of this clock signal.

### Configuration of Touch Sensor 111

FIG. 3A is a front view of a steering wheel including a touch sensor as an operation unit, and FIG. 3B is a schematic diagram illustrating the touch sensor (development view) and a controller thereof. As shown in FIG. 3A, the touch sensor 111 is mounted on a surface of an electrostatic sensor built-in grip 110 provided on an operation unit 101 of the steering wheel 100, and is an electrostatic capacitance type touch sensor for detecting a position on an operation input portion 112 touched (contact and proximity), for example, by a part of the body of an operator (for example, fingers). The touch sensor 111 can detect a touch state (presence or absence of touch by the holding fingers, a number of fingers touched and determination of either the left or right hand by determining the thumb) to the operation input portion 112 and operations such as a tracing operation, which is made by touching consecutively, and can determine an operation command of the fingers based on such detection. An operator can, for example, operate a vehicle-mounted device and the like such as an operation target device 300 being connected by performing touch operations to the operation input portion 112. The operation input portion 112 is set with operation input standard coordinates (x, y) in which the top left portion is the point of origin O, the right direction is the x-axis and the downward direction is the y-axis, as shown in FIG. 3B.

The operation input portion 112 includes, as shown in FIG. 3B, a plurality of driving electrodes 115, a plurality of detection electrodes 116, a driving unit 113 and a reading unit 114. The operation input portion 112 is set so that the top left portion of the paper on which FIG. 3B is printed is set as the point of origin, the x-axis extending to the right direction from the left and the y-axis extending to the downward direction from the top are also set. The x-axis and y-axis become the input standard for touch operations as the operation input coordinates (x, y).

The driving electrodes 115 and the detection electrodes 116 are, for example, configured as electrodes using tin-doped indium oxide (ITO), copper or the like. The driving electrodes 115 and the detection electrode 116 are arranged at the lower part of the operation input portion 112, each being insulated and intersecting with each other.

The driving electrodes 115 are, for example, arranged in parallel with the x-axis with equal intervals inbetween on the paper surface of the FIG. 3B and are also electrically connected to the driving unit 113. The controller 18 provides driving signals S1a periodically by switching the connection between the driving electrodes 115.

The detection electrodes 116 are, for example, arranged in parallel with the y-axis with equal intervals inbetween on the paper surface of the FIG. 3B and are also electrically connected to the reading unit 114. The reading unit 114 switches periodically the connection with the detection electrodes 116 while a driving signal S1a is provided to a single driving electrode 115 and reads out the electrostatic capacitance generated by the combination of the driving electrodes 115 and the detection electrodes 116. As an example, the reading unit 114 generates a detection signal S1b as an electrostatic capacitance count value by performing an analog digital conversion processing and the like to the electrostatic capacitance that is read out and outputs the generated detection signal S1b to the controller 18.

The detection signal S1b is generated in accordance with a set resolution. Specifically, the reading unit 114 performs processing to obtain the detection signal S1b by combining coordinates x1 to coordinates xn, coordinates y1 to coordinates ym, and the electrostatic capacitance count value, as shown in FIG. 3B and the like. The detection value distribution information 150 may be generated as the coordinates (x, y) which exceed a threshold value of the predetermined electrostatic capacitance is considered to be touched.

### Configuration of Vibration Actuator 120

A vibration actuator 120 as a notification means may utilize various actuators as long as the actuator is of a configuration in which vibration is generated by applying a voltage or an electric current. As shown in FIG. 2 and FIG. 3A, the vibration actuator 120 is mounted on a steering wheel and a vibration presentation as a tactile sensation feedback is performed while a driver is in a state of holding the steering wheel. For example, the vibration actuator is mounted on an end portion side of an electrostatic sensor built-in grip 110.

The vibration actuator 120, for example, may use an eccentric rotation motor including an eccentric rotor. For example, the eccentric rotor is formed of a metal such as brass, and functions as an eccentric weight during a rotation of a rotation motor in a state of being mounted on a rotational axis because the center of gravity thereof is set to be in a position eccentric from the rotational axis. Therefore, when the rotation motor rotates while being mounted with the eccentric rotor, because of the eccentricity of the eccentric rotor, the eccentric rotor causes a whirling movement about the rotational axis, resulting in generating vibrations in the rotation motor, thus functioning as the vibration actuator.

Moreover, the vibration actuator 120, for example, may be a monomorph piezoelectric actuator provided with a metal plate and a piezoelectric element. The monomorph piezoelectric actuator is a vibration actuator having a structure which bends with only one piezoelectric element layer. Examples of the material of the piezoelectric element include lithium niobate, barium titanate, lead titanate, lead zirconate titanate (PZT), lead metaniobate, polyvinylidene fluoride (PVDF), and the like. Note that, as a modification of the vibration actuator, a bimorph piezoelectric actuator in which two sheets of piezoelectric elements are provided on both sides of a metal plate may be used.

### Configuration of Display Portion 130

A display portion 130 as a notification means, for example, is configured to function as the display portion of an operation target device and the display portion of a vehicle-mounted device. The display portion 130 is, for example, a liquid crystal monitor arranged on a center console 90. The display portion 130, for example, displays a menu screen, images and the like, related to a display image 141. The related menu screen and the images are, for example, icons and the like of the menu screen of the functions that can be operated by a touch sensor 111. The icons enable selection, decision and the like, for example, by a touch state (presence or absence of the touch by the holding fingers, a number of fingers touched and determination of either the left or right hand by determining of the thumb) to an operation input portion 112 of the touch sensor 111 and an operation such as a tracing operation that is made by touching consecutively.

### Projection Portion 140

A projection portion 140 as a notification means, for example, as shown in FIG. 1, is arranged on a ceiling 91 between a set of the driver and a seat of the passenger. Note that, the arrangement position of the projection portion 140 is not limited to the ceiling 91 and may be decided in accordance with the arrangement of an operation input device 1.

The projection portion 140, for example, is configured to generate a display image 141 based on the image information S2 acquired from a controller 18 and to project the generated display image 141 onto the back of fingers 200 of an operator. The display image 141 may be a symbol, pattern, diagram and the like corresponding to an operation command by the fingers determined by a gesture operation.

The projection portion 140 is, as an example, a projector having a light-emitting diode (LED) as a light source. The projection portion 140 projects, as shown in FIG. 2, a display image 141 taking into consideration that the display image 141 is projected on the back of the hand of fingers 200 operating the steering wheel 100. In other words, the display image 141 is generated in a manner which enables easy recognition even if being projected on the back of the hand. Note that, the image information S2 is formed based on the position of the electrostatic sensor built-in grip 110 to be projected after detecting a center of gravity position of the fingers 200, to be described later, therefore, the display image 141 can be projected accurately on the back of the hand of fingers 200 holding the electrostatic sensor built-in grip 110.

### Behavior of the Operation Input Device

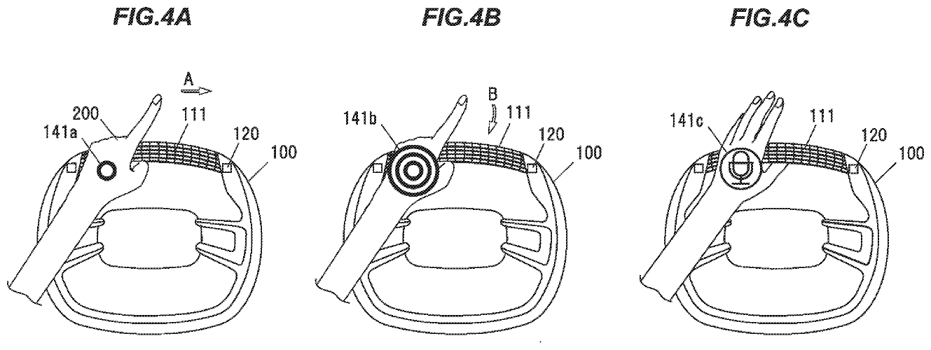

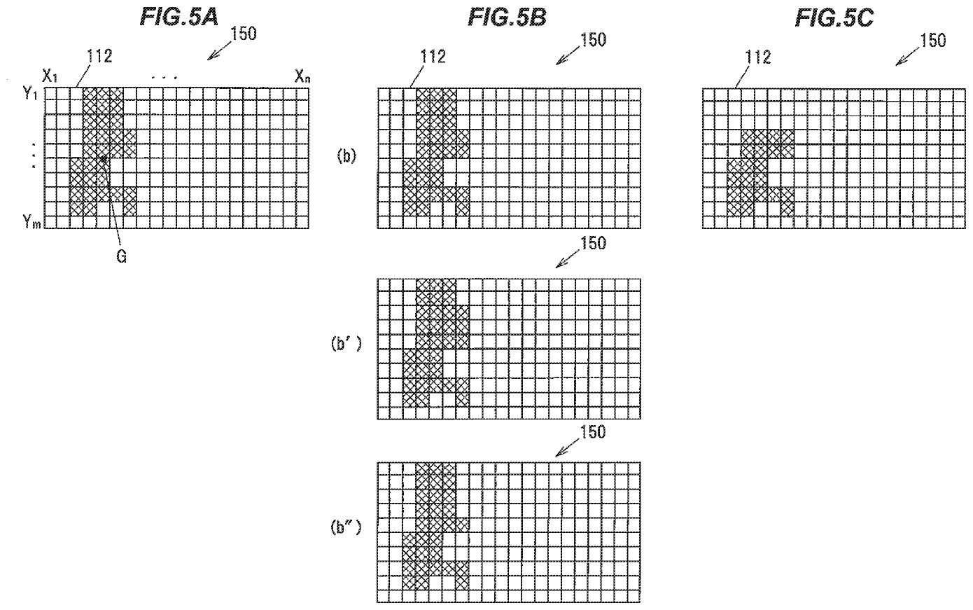

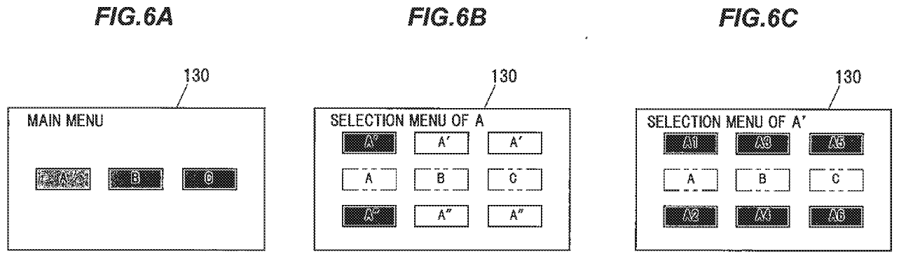

FIG. 4A is an example of a gesture when holding a touch sensor with one finger being extended to perform a slide operation in a direction of an arrow A, FIG. 4B is an example of a gesture when holding a touch sensor with one finger being extended to move the finger (forefinger) in a vertical direction of an arrow B, and FIG. 4C is an example of a gesture with four fingers being raised. FIG. 5A is a diagram illustrating a touch region of a touch sensor (development view) corresponding to FIG. 4A as a hatching region, FIG. 5B is a diagram illustrating a touch region of a touch sensor (development view) corresponding to FIG. 4B as a hatching region, and FIG. 5C is a diagram illustrating a touch region of a touch sensor (development view) corresponding to FIG. 4C as a hatching region. Further, FIG. 6A is an example of a main menu displayed on a display portion as a result of a gesture operation shown in FIG. 4A, FIG. 6B is an example of a selection menu of A displayed on the display portion as a result of a gesture operation shown in FIG. 4B, and FIG. 6C is an example of a selection menu of N displayed on the display portion as a result of a gesture operation shown in FIG. 4C. Hereinafter, the operation of the operation input device will be described with reference to these diagrams.

### Detection of Input Operation by Touch Sensor 111

As illustrated in FIG. 4A, a case is to be considered in which an operator (driver) is holding an electrostatic sensor built-in grip 110 with the left hand, for example, with a forefinger being extended. FIG. 5A shows a touch region of a touch sensor 111 (development view) of this holding state as a hatching region.

A controller 18 may obtain a center of gravity position of the touch region from the above-described hatching region. An X-coordinate at the position of the center of gravity G is an average value taken from the values in FIG. 5A. The average value can be calculated by dividing a total of the value of the pixels of the X-coordinate where the hatching region exists by a number of pixels where the hatching region exists. Similarly, a Y-coordinate at the position of the center of gravity G is an average value taken from the values in FIG. 5A. The average value can be calculated by dividing a total of the value of the pixels of the Y-coordinate where the hatching region exists by a number of pixels where the hatching region exists. As illustrated in FIG. 5A, the center of gravity G (x, y) may be calculated by the above-described calculation of the center of gravity, taking the bottom left as the point of origin O, right direction as X and the upper direction as Y. Note that, a touch region exceeding a threshold value is calculated as the hatching region, however, by performing a multi-value detection, a position of a center of gravity G can be calculated by adding weight in each of the hatching region.

The controller 18 may determine a touch state of fingers from the above-described hatching region. As illustrated in FIG. 4A, a case is to be considered in which the operator (driver) is holding the electrostatic sensor built-in grip 110 with the left hand, for example, with the forefinger being extended. FIG. 5A shows a touch region of the touch sensor 111 (development view) of this holding state as the hatching region. From this hatching region, with a pattern matching of a known art, it is possible to determine the touch state of the fingers, in which position, in which angle and with which fingers the electrostatic sensor built-in grip 110 is being held, and with either left or right hand, etc.

For more accuracy to be achieved in the above-described determination, templates for various pattern matchings are to be stored in a memory. The templates for various types of holdings such as holding with the right hand, holding with the left hand, holding with an extended forefinger and holding with four fingers extended are to be prepared. Further, it is possible to detect accurately a positional relationship of the hand and a movement of the finger by calibrating a width of the hands and the like per each operator.

### Input Operation Case Shown in FIG. 4A

In an input operation shown in FIG. 4A, an operator holds an electrostatic sensor built-in grip 110 with the left hand while extending the forefinger, and a trace (slide) operation is made in the direction of an arrow A in the diagram.

By such input operation, a hatching region as a touch region of a touch sensor 111 (development view) shown in FIG. 5A can be detected. This hatching region is used as detection value distribution information 150 for calculation of a center of gravity position and pattern matching described above.

A controller 18 can determine that the operator is making a trace (slide) operation in the direction of the arrow A in the diagram with the forefinger of the left hand being extended. This may be determined by a change in the position of the center of gravity G, the pattern matching based on the detection value distribution information 150 or the like.

The controller 18 can determine, based on the gesture operation of the above-described input operation, an operation command made by the fingers. Thus, the controller 18 selects a main menu of a display portion 130 shown in FIG. 6A, for example, by the display information S3. With this operation, an operation control of an operation target device 300 can be performed with control information S4.

The controller 18, as shown in FIG. 4A, projects and displays a circle symbol 141a as a display image 141 on the back of the hand of the fingers 200 with image information S2. Further, the controller 18 performs a tactile sensation feedback by vibration to the operator and the fingers 200 of the operator by driving a vibration actuator 120 with vibration information S5.

### Input Operation Case Shown in FIG. 4B

In an input operation shown in FIG. 4B, an operator holds an electrostatic sensor built-in grip 110 with the left hand with the forefinger being extended, and an operation is made with the forefinger moving in the vertical direction of B in the diagram.

By such input operation, a hatching region as a touch region of a touch sensor 111 (development view) can be detected as in FIGS. 5B(b), 5B(b′) and 5B(b″). This hatching region is used as detection value distribution information 150 for calculation of the center of gravity position and the pattern matching described above. The hatching region of FIG. 5B(b) is of a state in which the forefinger is being extended, and denotes the same pattern as in FIG. 5A. FIG. 5B(b′) is of a pattern in which the forefinger is lowered while being extended, and the hatching region corresponding to the forefinger is increased. On the other hand, FIG. 5B(b″) is of a pattern in which the forefinger is raised while being extended, and the hatching region corresponding to the forefinger is decreased.

A controller 18 can determine that the operator is making a vertical movement operation of the finger with the forefinger of the left hand being extended. This may be determined by a change in the detection value distribution information 150, the pattern matching or the like, described above.

The controller 18 can determine, based on the gesture operation of the above-described input operation, the operation command made by the fingers. Thus, the controller 18 selects a selection menu of A of the display portion 130 shown in FIG. 6B, for example, by the display information S3. With this operation, an operation control of an operation target device 300 can be performed with control information S4.

The controller 18, as shown in FIG. 4B, projects and displays a ripple symbol 141b as a display image 141 on the back of the hand of the fingers 200 with image information S2. The ripple symbol 141b, for example, enlarges at the top and downsizes at the bottom in accordance with the vertical movement of the forefinger. Further, the color changes in accordance with the selected menu. The controller 18 performs a tactile sensation feedback by vibration to the operator and the fingers 200 of the operator by driving a vibration actuator 120 with vibration information S5.

### Input Operation Case Shown in FIG. 4C

In an input operation shown in FIG. 4C, an operator holds an electrostatic sensor built-in grip 110 with the left hand with the four fingers being extended to perform an operation.

By such input operation, a hatching region as a touch region of a touch sensor 111 (development view) shown in FIG. 5C can be detected. This hatching region is used as detection value distribution information 150 for calculation of the center of gravity position and the pattern matching described above.

The controller 18 can determine that the operator holds the electrostatic sensor built-in grip 110 with the four fingers being extended. This may be determined by the position of a center of gravity G, the pattern matching based on the detection value distribution information 150 and the like.

The controller 18 can determine, based on the gesture operation of the above-described input operation, the operation command made by the fingers. Thus, the controller 18 selects a selection menu of A′ of a display portion 130 shown in FIG. 6C, for example, by display information S3. With this operation, the operation control of an operation target device 300 can be performed with control information S4.

The controller 18, as shown in FIG. 4C, projects and displays a microphone symbol 141c as a display image 141 on the back of the hand of fingers 200 with image information S2. With this, a microphone 11 becomes a state in which input is possible, thus enabling voice input. Further, the controller 18 performs a tactile sensation feedback by vibration to the operator and the fingers 200 of the operator by driving a vibration actuator 120 with vibration information S5.

### Effect of Embodiment of Present Invention

According to an embodiment, effects such as those described below are achieved.

(1) An operation input device 1 according to the embodiment includes a touch sensor 111 that is a touch detector configured to detect an operation state to an operation unit 101 of a steering wheel 100 of a vehicle 9, a controller 18 configured to determine an operation command by fingers of an operator to the touch sensor 111 based on a touch state of the fingers 200 of the operator to the touch sensor 111 and to operate an operation target device and a notification unit for notifying an operator based on the operation command by the fingers determined by the controller 18. Thus, safe operation is made possible by including a traffic status in the forward direction, a display and an operation hand in the same view.

(2) A gesture input while holding a steering wheel 100 (electrostatic sensor built-in grip 110) enables the operation to be performed in a stable manner. Further, at the same time, by providing a tactile sensation feedback linked with operations, operational feeling is improved.

(3) By projecting an operation content linked with a movement of hands, not only the operator but also a passenger can comprehend the operation content.

(4) Further, it is possible to detect accurately a positional relationship of the hand and a finger movement by calibrating a width of the hands per each operator.

(5) The detection system does not utilize camera images, therefore, no camera cost and no place for camera attachment is necessary.

Although several embodiments of the invention have been described above, these embodiments are merely examples and the invention according to the claims is not to be limited thereto. These novel embodiments may be implemented in various other forms, and various omissions, substitutions, changes and the like can be made without departing from the spirit and scope of the invention. In addition, all the combinations of the features described in these embodiments are not necessarily needed to solve the technical problem. Further, these embodiments are included within the spirit and scope of the invention and also within the invention described in the claims and the scope of equivalents thereof.

### Reference Signs List

1 Operation input device

9 Vehicle

18 Controller

100 Steering wheel

101 Operation unit

110 Electrostatic sensor built-in grip

111 Touch sensor

112 Operation input portion

113 Driving unit

114 Reading unit

115 Driving electrode

116 Detection electrode

120 Vibration actuator

130 Display portion

140 Projection portion

1. An operation input device, comprising:
a touch detector configured to detect an operation state to an operation unit of a steering wheel of a vehicle;
a controller configured to determine an operation command by fingers of an operator to the touch detector based on a touch state of the fingers of the operator to the touch detector and to operate an operation target device; and
a notification unit for notifying the operator based on the operation command by the fingers determined by the controller.

2. The operation input device according to claim 1, wherein the operation command by the fingers is a gesture input by a hand of the operator.

3. The operation input device according to claim 1, wherein the touch detector is of an electrostatic capacitance sensor.

4. The operation input device according to claim 1, wherein the notifying based on the operation command by the fingers is a display of an operation menu of the operation target device.

5. The operation input device according to claim 1, wherein the notifying by the fingers based on the operation command is a display of a projected image on a hand of the operator.

6. The operation input device according to claim 1, wherein the notifying by the fingers based on the operation command is a vibration presentation to the operator.

7. The operation input device according to claim 1, wherein the operation unit of the steering wheel includes an electrostatic sensor built-in grip, and
wherein the touch detector is mounted on a front surface of the electrostatic sensor built-in grip.

8. The operation input device according to claim 1, wherein the touch detector includes an operation input portion, and
wherein the operation input portion includes a plurality of driving electrodes arranged with equal intervals in a predetermined direction, a plurality of detection electrodes arranged with equal intervals in an orthogonal direction to the predetermined direction, a driving unit configured to provide driving signals to the plurality of driving electrodes, and a reading unit configured to read out electrostatic capacitance generated by a combination of the plurality of driving electrodes and the plurality of detection electrodes.

9. The operation input device according to claim 1, wherein the notifying by the fingers based on the operation command is a projected image displayed on a hand of the operator while the operation unit of the steering wheel is held by the hand.
